(19) United States
(12) Patent Application Publication
(10) Pub. No.: US 2003/0200203 A1
(43) Pub. Date: Oct. 23, 2003

(54) Information processing method and information processing system

(75) Inventor: Yuji Terada, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/286,859

(22) Filed: Nov. 4, 2002

(30) Foreign Application Priority Data
Apr. 18, 2002 (JP) 2002-116608

(51) Int. Cl. G06F 7/00

(52) U.S. Cl. 707/3

(57) ABSTRACT

An information processing method and an information processing system store information that is recognized differently depending on an individual in correspondence with a predetermined attribute, and provide information for making a determination when information of a person who makes an input is entered. Additionally, the address of a person who makes an input is identified, the address and weather information input by a user whose address is the vicinity of the address are read from a database, a statistical process is performed for the read data, and the data is transmitted to a terminal of the person who makes an input. This transmitted data is a result of the statistical process, which is weather determined by residents in a corresponding region and place name, and is the most effective information. Accordingly, if a plurality of options exists for an input of weather information, by way of example, when weather information is input to a diary, etc., option information of other users can be referenced, and an option can be made with ease in a short time.

### BACKGROUND OF THE INVENTION

1. Field of the Invention

The present invention relates to an information processing method and an information processing system that store information which is recognized differently by an individual in correspondence with a predetermined attribute (such as an individual attribute), and provide helpful information to a user who desires to input information from terminal equipment.

2. Description of the Related Art

Examples of information that is recognized differently by an individual includes “weather information”. Even the same weather is sometimes recognized to be “fine” or “cloudy” by an individual. This phenomenon occurs not only for “weather” information, but also for the color, the shape, or the like of a target commodity, or the like at the time of a commodity purchase. Such items of information are recognized differently depending on a feeling of an individual.

Accordingly, for information that is recognized differently by a feeling of an individual, it is difficult to identify the contents of the information. Especially, it is noticeable to identify past information.

For example, if an individual writes “weather” information in his or her diary, etc., the “weather” information depends on the feeling of the individual, and correct “weather” information cannot always be written. Even more, accuracy of the contents of past “weather” information is further degraded if the information is remembered and written.

Additionally, for example, on net shopping using a Web site, or the like, it is possible to easily decide a commodity to be purchased if its color and shape are displayed in a photo showing the commodity, or the like. However, it is difficult to decide a commodity to be purchased if its color and shape are expressed only in a description. This is because there is a high possibility that a difference exists between the feeling of a Web site creator and that of a commodity purchaser for the color and the shape of the commodity.

Furthermore, for the color, the shape, etc. of a commodity, trends of popularity or likings vary by an individual attribute such as a region (a domicile of a commodity purchaser), age, gender, etc. Although a commodity purchaser desires to get a popular commodity, he or she must uniquely conduct a survey on information about popularity or likings associated with such individual attributes via a magazine or telecasting. It is difficult for an individual to obtain such information.

Conventionally, the applications of Japanese Patent Publication Nos. 2000-207412 and 09-153054 were filed as the above described techniques for obtaining such information. The application of Japanese Patent Publication No. 2000-207412 reveals a configuration for obtaining positional information of a user, and for making a conditional search. For example, information of stores in a predetermined range is searched based on current positional information of a user, and provided to the user. Additionally, stores are classified by genre. For instance, if the user especially desires to learn restaurant information, he or she can obtain more detailed information by selecting the corresponding genre. Furthermore, the likings of users are learned according to selected genre information, and used as customer information for banner advertising or an information provider side.

Furthermore, the application of Japanese Patent Publication No. 09-153054 reveals a configuration for providing a search result in association with positional information of a user. With this configuration, information input from a sensor, which includes a search command, is transmitted to a network, and a result is received. The above described information includes image information, contents desired by a user, and positional information. A search result is received based on the positional information. For instance, if a plurality of ticket providers exist at the time of a ticket purchase, a nearer ticket provider is selected by making a comparison among positional information.

The above described conventional techniques have the following problems. Namely, the former application provides not marketing information that includes regional distribution information, but only a search result to which positional information of a user is added. That is, a user can obtain regional information, but does not obtain further detailed information. Therefore, the user cannot learn, for example, the likings or the popularity of residents in the same region, and cannot use the information at the time of a commodity purchase, etc. Also when “weather” information, etc. is input to a diary, etc., information of regional residents cannot be effectively used.

The latter application only displays information based on positional information of a user, and cannot extract helpful regional information. Namely, it is impossible to learn regional information and to obtain information of recognition, popularity, etc. of regional residents from a search result. Accordingly, whether to adopt or to drop a search result depends on a user determination, which requires a time, so that a quick process cannot be performed.

### SUMMARY OF THE INVENTION

An object of the present invention is to provide an information processing method and an information processing system that can easily obtain required information in a short time by referencing option information of other users, if a plurality of options exist for a condition. Another object of the present invention is to provide an information processing method and an information processing system that can obtain and input such information.

Namely, the above described objects can be achieved by providing an information processing method comprising: storing information that is recognized differently depending on an individual in a storing unit in correspondence with a predetermined attribute; searching the storing unit according to an attribute specified by a terminal, and reading information corresponding to the attribute; performing a statistical process for the information read by said searching, and transmitting the information to the terminal; and inputting information determined based on statistical information transmitted by said transmitting.

Here, the above described information is read from a table storing, for example, a place name corresponding to a region beforehand, and registered to, a database of calendar input information, for example, along with date information. This information is provided from terminals of many users, and registered to the database. The data thus registered to the database is read according to an instruction specifying a place name, a statistical process is performed for the read data, and the data is transmitted to a user terminal.

With this configuration, a user can suitably determine input information by referring to information made visible on a display of his or her terminal.

Additionally, the objects of the present invention can be achieved by providing an information processing server which is connected to a terminal via a network, and comprises: a storing unit storing information that is recognized differently depending on an individual in a storing unit in correspondence with a predetermined attribute; a searching unit searching the storing unit according to an attribute specified by a terminal, and reading information corresponding to the attribute; and a transmitting unit performing a statistical process for the information read by said searching unit, and transmitting the information to the terminal.

This invention is an invention of an information processing server. Also with this invention, information is stored along with date information, and data registered to a database is read based on a place name specification, a statistical process is performed for the read data, and the data can be transmitted to a user terminal, so that the user can input suitable information by referring to regional information displayed on his or her terminal.

### BRIEF DESCRIPTION OF THE DRAWINGS

FIG. 1 shows the configuration of an information processing system according to the present invention;

FIG. 2 schematically explains the configuration of a server;

FIG. 3 exemplifies a calendar input information database;

FIG. 4 exemplifies a monthly calendar display;

FIG. 5 exemplifies a weekly calendar display;

FIG. 6 exemplifies a daily calendar display;

FIG. 7 is a flowchart explaining a process for inputting “weather” information;

FIG. 8A shows an input screen for weather information by selecting an option button in a daily display state;

FIG. 8B shows an input screen for “weather” information in the daily display state;

FIG. 9 is a flowchart specifically explaining a process of step 1 shown in FIG. 7;

FIG. 10 shows the relationship between a region and a place name;

FIG. 11 is a flowchart specifically explaining a process of step 2 shown FIG. 7;

FIG. 12 exemplifies an input information listing;

FIG. 13 is a flowchart specifically explaining a process of step 3 shown in FIG. 7;

FIG. 14 is a flowchart specifically explaining a process of step 4 shown in FIG. 7;

FIG. 15 is a flowchart explaining a second preferred embodiment;

FIG. 16 explains the configuration of a purchase information database;

FIG. 17 is a flowchart specifically explaining a process of step 1 shown in FIG. 15;

FIG. 18 is a flowchart specifically explaining a process of step 2 shown in FIG. 15;

FIG. 19 is a flowchart specifically explaining a process of step 3 shown in FIG. 15;

FIG. 20 is a flowchart specifically explaining a process of step 4 shown in FIG. 15; and

FIG. 21 explains an input screen for color information.

### DESCRIPTION OF THE PREFERRED EMBODIMENTS

Hereinafter, preferred embodiments according to the present invention are explained with reference to the drawings.

<First Preferred Embodiment>

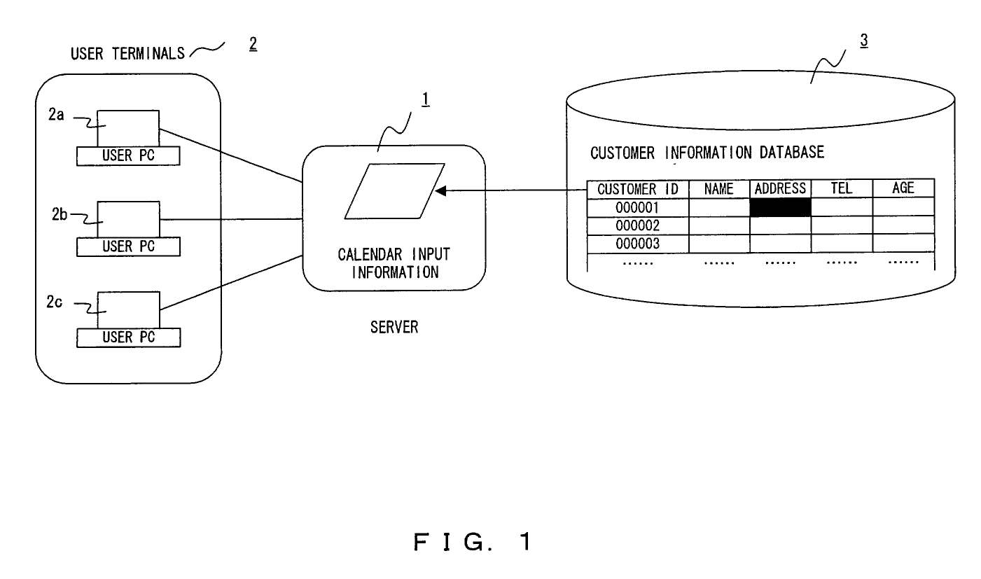

FIG. 1 shows the configuration of an information processing system, which is intended to explain a first preferred embodiment according to the present invention. In this figure, the system according to this preferred embodiment is configured by a server 1 and user terminals 2. The server 1 is connected to a storage device 3. The server 1 and the user terminals 2 are connected by a network such as the Internet, etc.

The user terminals 2 are, for example, personal computers (PCs) 2a, 2b, 2c, . . . , possessed by users. Cellular phones, PDAs (Personal Digital Assistants), etc., which have a function for connecting to the server 1, are also available as the user terminals 2. The users are customers registered to, for example, a commodity purchase site operated by the server 1. The server 1 renders a calendar service to be described later as one of customer services.

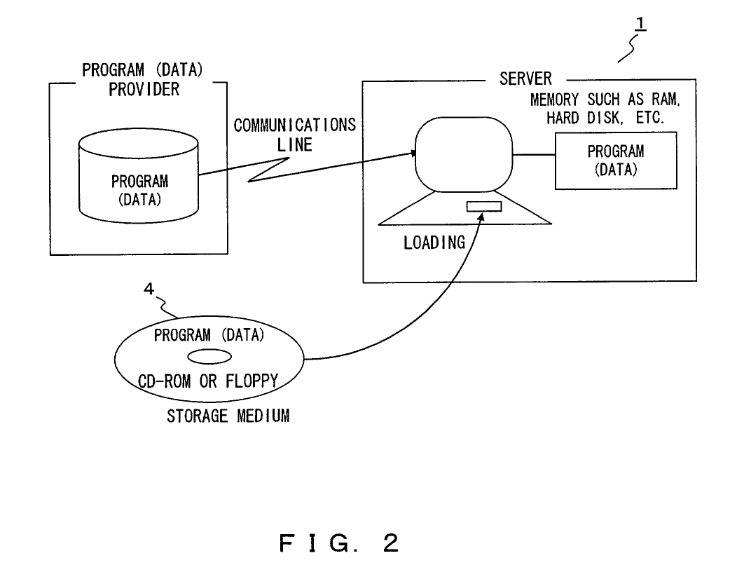

FIG. 2 schematically explains the configuration of the above described server 1. The server 1 is configured by a CPU, a ROM, a RAM, a hard disk, etc. The server 1 performs processes according to a program stored onto the hard disk, etc., writes information to be described later to the above described storage device 3 (see FIG. 1) connected to the server 1, and reads information from the storage device 3 as occasion demands. User (customer) information, weather information, etc., which will be described later. The registered to the storage device 3. The above described hard disk may be used also as the storage device 3.

Additionally, the processes in this preferred embodiment may be performed by using a program provided via a communications line. Or, a storage medium 4 such as a floppy disk, a CD-ROM, etc. may be inserted in a drive arranged in the server 1, and the above described program may be read from the storage medium 4 and used.

Furthermore, the program may be received from another device via a network, and used.

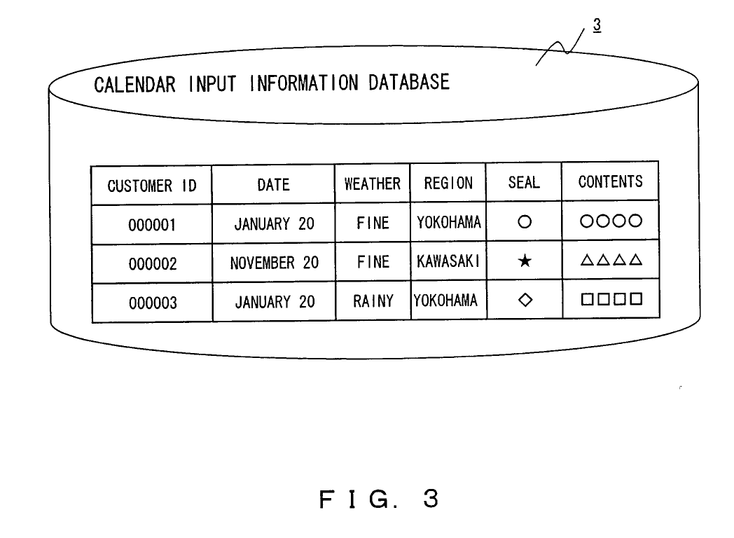

In the storage device 3, a customer information database, which stores names, addresses, telephone numbers, ages, etc. of customers (users), is built as shown in FIG. 1. Also a calendar input information database shown in FIG. 3 is built. This calendar input information database is configured by a customer ID storage area, a date storage area, a weather information storage area, a regional information storage area, a seal information storage area, and a contents storage area as shown in FIG. 3.

Here, to the customer ID storage area, ID numbers of customers who subscribe this system are registered, for example, in their subscription order. The date storage area stores dates that are used by calendar services, and correspond to the “weather” information at the same time. Additionally, the regional information storage area indicates information of addresses or current locations of corresponding customers (users). The weather information storage area indicates weather in the regions, and is input by selecting a weather icon to be described later. The contents storage area stores individual schedules, variety of types of information, comments, etc. The seal information storage area represents an even or an incident on the corresponding day as a symbol image.

The storage device 3 shown in FIGS. 1 and 3 stores information of an input information listing and an option listing database, which are described later, in addition to the above described user information database and calendar input information database.

Specific processes in this embodiment are explained next. This embodiment refers to a configuration where also weather information can be written as one of calendar services at a Web site, which are rendered by the server 1. Accordingly, a calendar function used in this preferred embodiment is first explained.

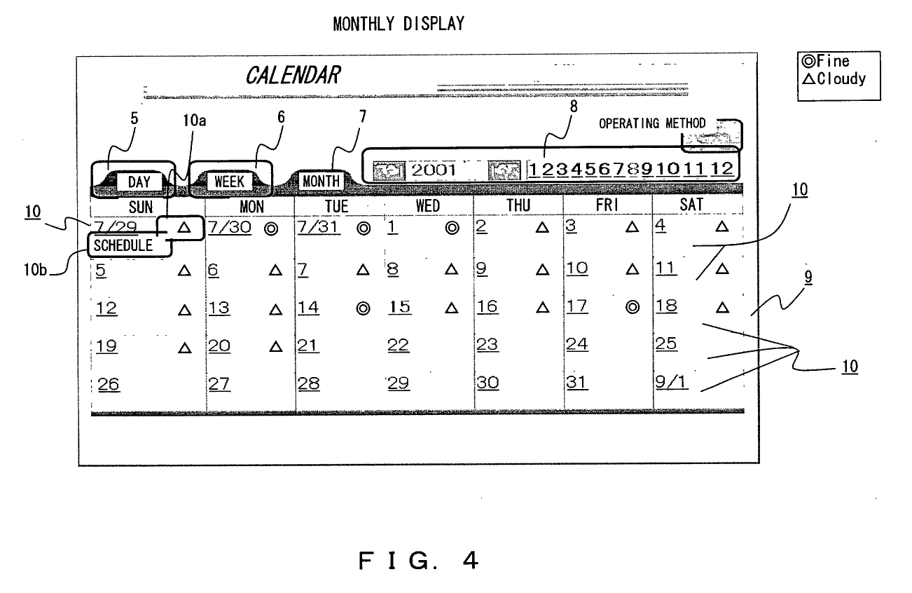

FIG. 4 exemplifies a calendar display, which is configured by a daily display switching tab 5, a weekly display switching tab 6, a monthly display switching tab 7, a display switching link 8, and a calendar display portion 9. This calendar display is made visible on a user terminal 2 based on a calendar service selection made by a user, after an access is made to the server 1, and, for example, a home page is displayed.

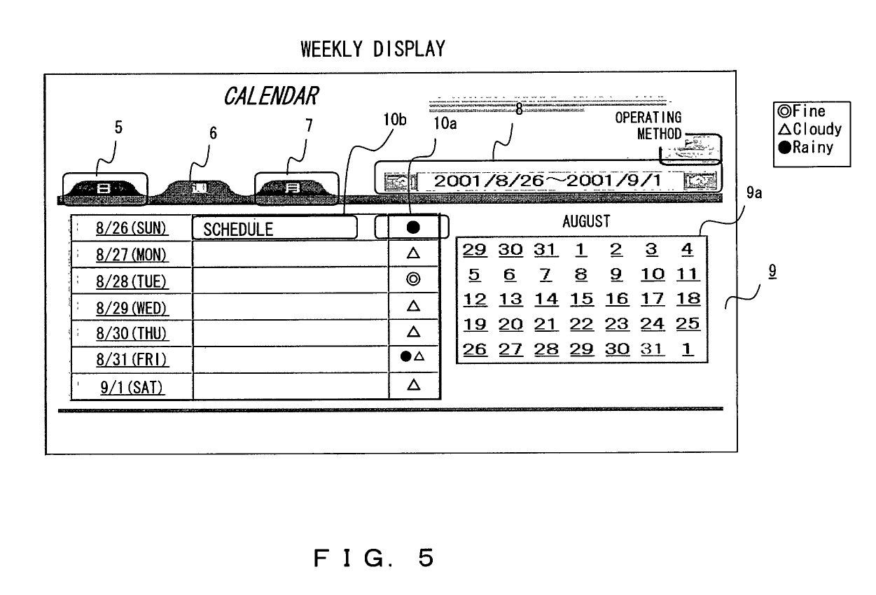

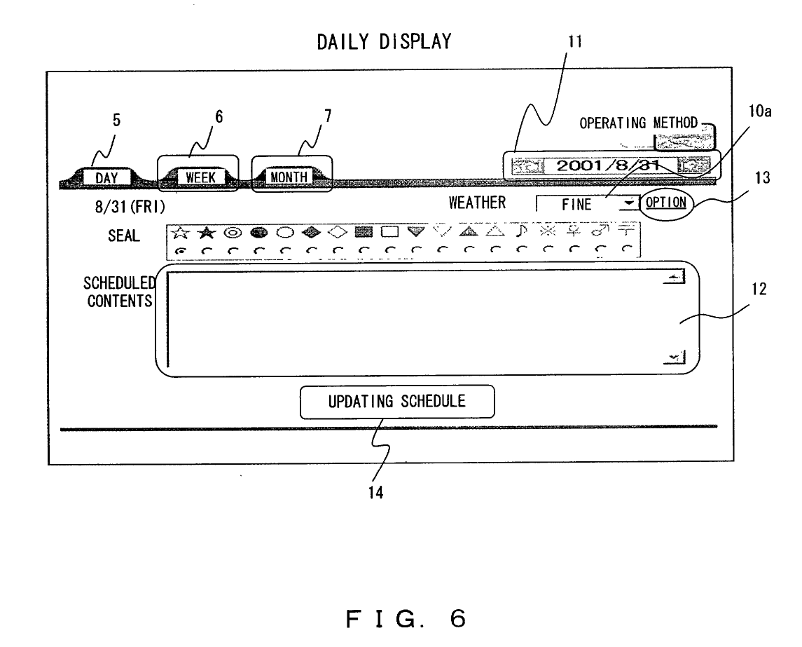

Here, a calendar display specified with any of the switching tabs 5 to 7 is made visible in the calendar display portion 9. This display switching is made by specifying any of the switching tabs 5 to 7. For example, FIG. 4 shows a monthly calendar display, which is a display made by specifying the monthly display switching tab 7. FIG. 5 shows a weekly calendar display, which is made by specifying the weekly display switching tab 6. FIG. 6 shows a daily calendar display, which is made by specifying the daily display switching tab 5.

Here, for the monthly display shown in FIG. 4, a calendar of a specified month is displayed in the calendar display portion 9, and a weather information display portion 10a and a contents display portion 10b of a schedule are generated in each of date areas 10. In the weather information display portion 10a, weather information input according to a process to be described later is displayed. In the contents display portion 10b, weather information input according to a process to be described later is displayed. Furthermore, in the contents display portion 10b, several characters of the beginning words of a schedule are displayed.

In the meantime, for the weekly display shown in FIG. 5, the weather information display portion 10a and the contents display portion 10b of a schedule are generated in a corresponding date area. For instance, in the example shown in FIG. 5, schedule and weather information of August 26 are displayed in the corresponding date area, and those of August 27 are similarly displayed in the corresponding date area. As shown in this figure, also a monthly display 9a including the corresponding week is made visible on the right side of the weekly display screen.

For the daily display shown in FIG. 6, the weather information display portion 10a is positioned immediately below a date display 11, and weather information is displayed. Additionally, a write portion 12 for scheduled contents is made visible on the daily display screen, and a write process for a schedule is performed. A schedule written in the write portion 12 for scheduled contents is contents to be displayed in the contents display portion 10b.

Furthermore, also an option button 13 is displayed in the weather information display portion 10a of the daily display screen. This option button 13 is a button specified when weather information to be displayed in the weather information display portion 10a is selected, and also used when weather information once set is changed. A process using this option button 13 will be described later.

A schedule update button 14 is used when a schedule is written in the write portion 12 for scheduled contents, or when a schedule once written is changed.

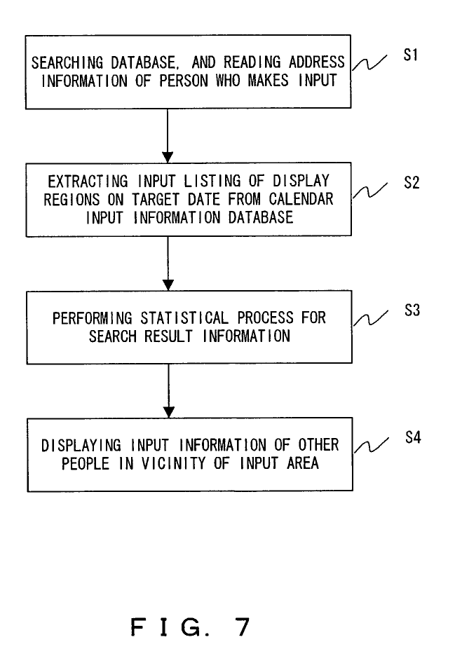

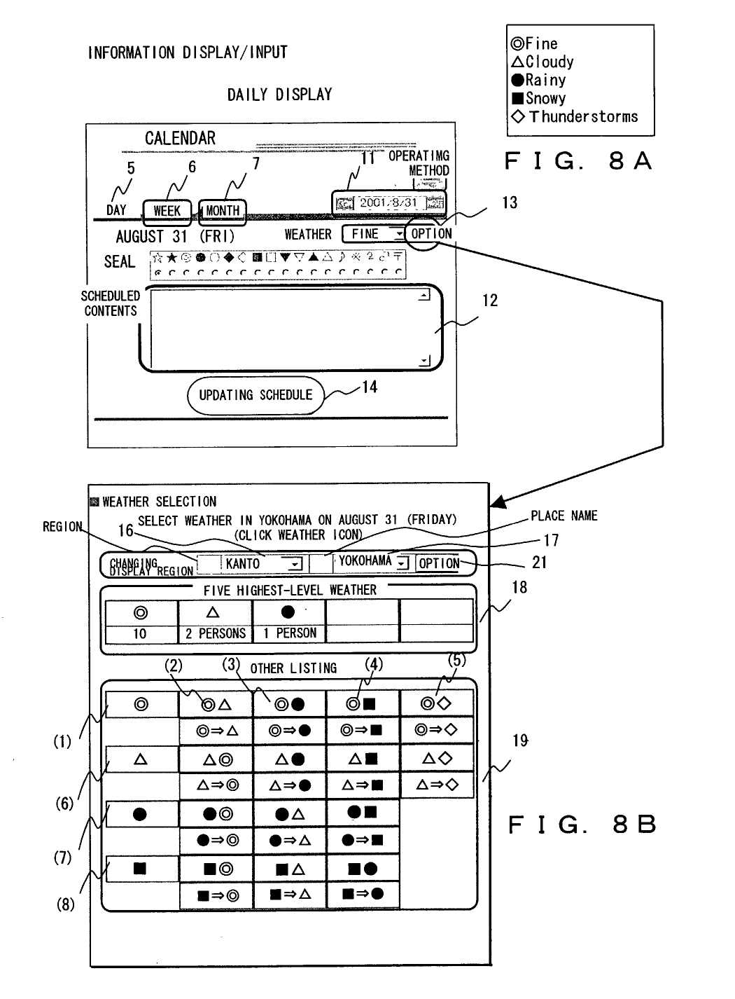

A process that a user performs to input weather information with the above described calendar function is explained next. A flowchart shown in FIG. 7 explains this process, which is started by specifying the above described option button 13 in the state of a daily display screen shown in FIG. 8A.

Firstly, the initial value of a display region is set based on the address of a person who performs the input process for weather information (hereinafter referred to as a person who makes an input) (step (hereinafter abbreviated to S) 1).

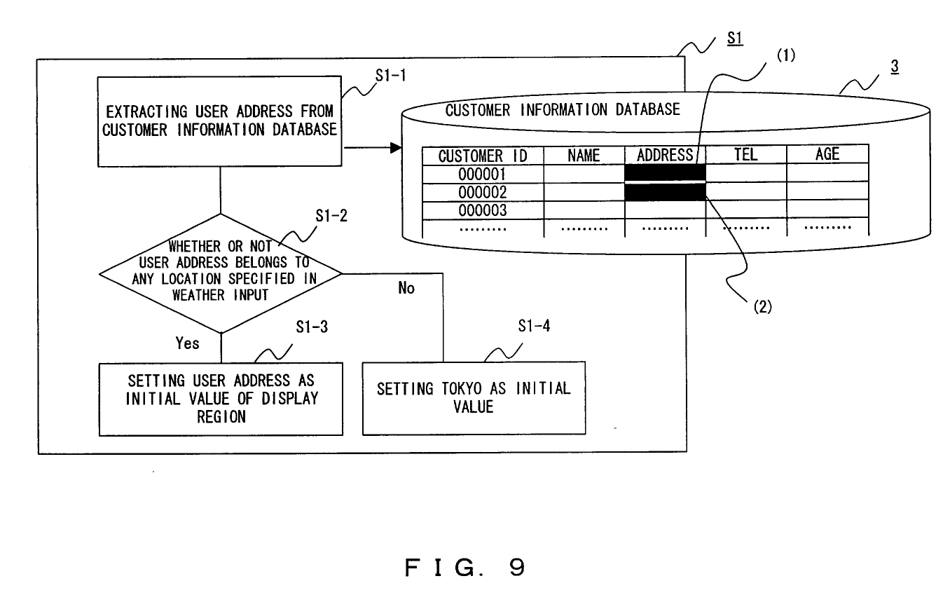

FIG. 9 is a flowchart explaining the details of the above described process (S1). Assume that a person who makes an input enters his or her customer ID and password to use each service rendered at this Web site, and receives user authentication beforehand, although this is not shown in this flowchart. With this user authentication, the server 1 can obtain the customer ID of the person who makes an input, and can reference various items of information, which correspond to this customer ID and will be described later.

Firstly, the address information of the person who makes an input is read out by searching the database based on customer information (S1-1). In this case, if the user who specifies the option button 13 is a user having a customer ID “000001”, the address information (information (1) shown in FIG. 9) of the corresponding customer is obtained. Or, if the user is a user having a customer ID “000002”, the address information of the corresponding customer (information (2) shown in FIG. 9) is obtained.

Next, it is determined whether or not the obtained address information belongs to any location specified in a weather input (S1-2). Here, if the address of the user belongs to a specified location (“YES” in S1-2), the address of the user is set as a display region (S1-3). Or, if the address of the user does not belong to the specified location (“NO” in step S1-2), Tokyo is tentatively set as the initial position (S1-4).

Namely, FIG. 8B is a screen displayed after a person who makes an input specifies the option button 13. For example, if a user goes out on a business trip or a journey, he or she inputs regional information to a regional input portion 16 by specifying an option button 21, and also inputs place name information to a place name input portion 17, so that the initial position is reset from Tokyo to the actual location.

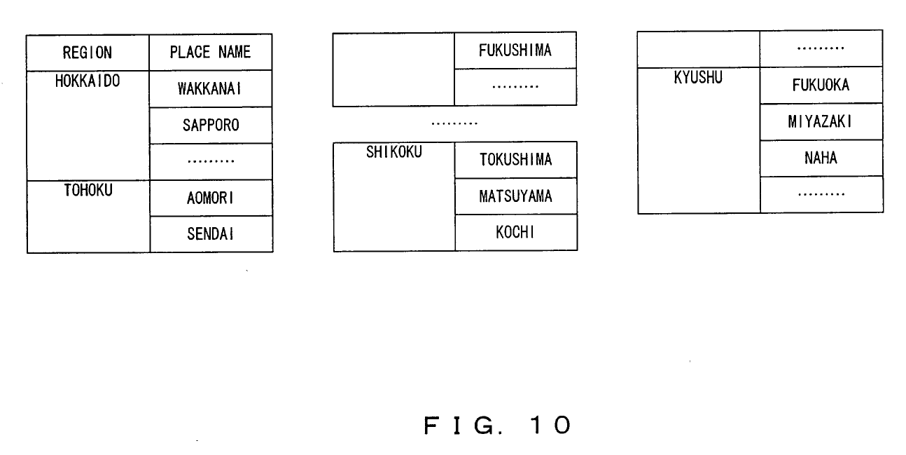

For example, “Kanto” and “Yokohama”, which correspond to the address of the user, are respectively displayed in the regional input portion 16 and the place name input portion 17 as default values. Additionally, FIG. 10 shows the relationships between the regional information and the place name information. By way of example, place name information “Wakkanai”, “Sapporo”, . . . correspond to regional information “Hokkaido”, and place name information “Aomori”, “Sendai”, “Fukushima”, . . . correspond to regional information “Tohoku”. Also the other regional information and place name information have similar relationships shown in this figure. Furthermore, the information shown in FIG. 10 are preregistered to the storage device 3, for example, in the form of a table.

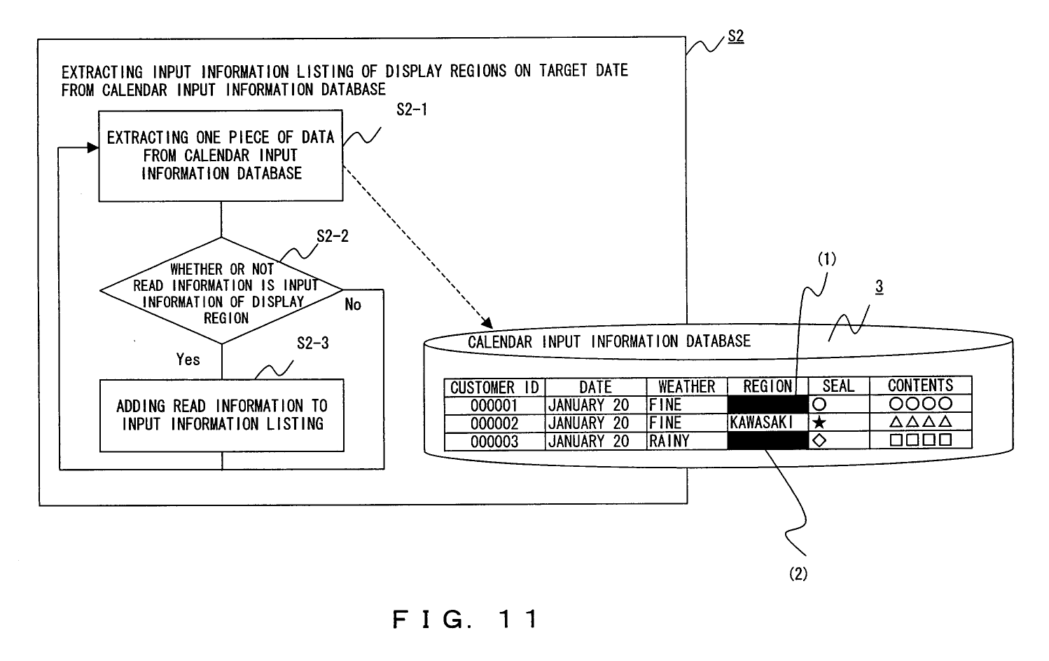

Next, an input listing of display regions on a target date is extracted from the calendar input information database (S2 shown in FIG. 7). FIG. 11 is a flowchart specifically explaining this process, in which one piece of data on the target date is firstly read from the calendar input information database (S2-1) For example, regional information of a customer ID “000001” ((1) shown in FIG. 11) on January 20 shown in this figure is read out, and a determination is made (S2-2). Namely, it is determined whether the read regional information is, for example, either “Yokohama” or a place name close to “Yokohama”.

Here, if the regional information satisfies this condition (“YES” in S2-2), this information is added to the input information listing (S2-3). Or, if the regional information does not satisfy the condition (“NO” in S2-2), the next piece of data is read from the calendar input information database (S2-1). For example, the next piece of data is regional information a customer ID “000003” ((2) shown in FIG. 11) of on January 20.

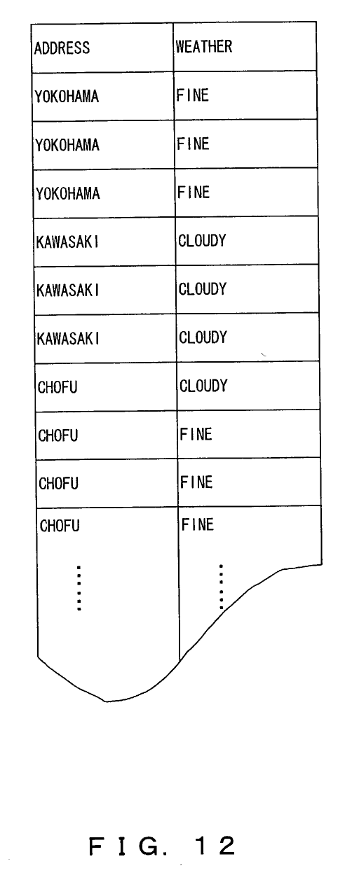

By repeating the above described process, weather information of, for example, “Yokohama” or a place name close to “Yokohama” is added to the input information listing. FIG. 12 exemplifies the input information listing generated with the above described process.

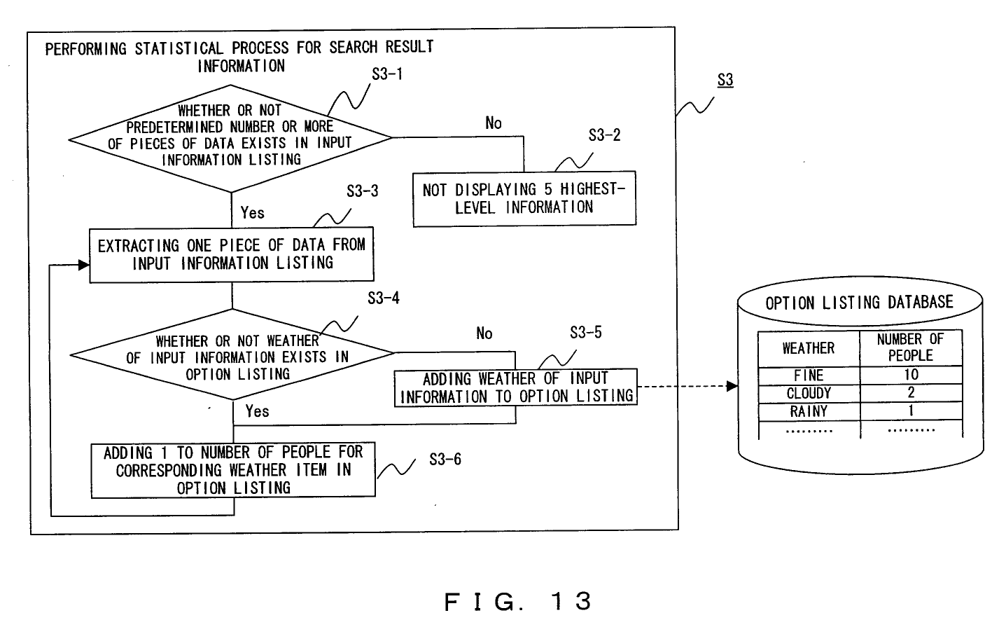

Next, a statistical process is performed for the search result (S3 shown in FIG. 7). FIG. 13 is a flowchart specifically explaining this process. Firstly, it is determined whether or not a predetermined number or more of pieces of data exists in the input information listing obtained with the search result (S3-1). Here, if the predetermined number or more of pieces of data does not exist in the input information listing (“NO” in S3-1), five pieces of weather information are not displayed (S3-2). This is because the amount of data is small, and weather information cannot be used as information for making a determination for a person who makes an input. In the meantime, if the predetermined number or more of pieces of data exists in the input information listing (“YES” in step S3-1), one piece of data is read from the input information listing (S3-3).

Next, to generate an option listing database, it is determined whether or not the read weather information is written in the option listing database (S3-4). This process is a process for determining whether or not the same weather information as the read weather information is already registered to the option listing database. Normally, read weather information is not registered to the option listing database in the initial process (“NO” in S3-4), and the read weather information is added to the option listing database (S3-5). For instance, in the example shown in FIG. 13, a weather information item “rainy” does not exist in the option listing database, and this item is added to the option listing database.

If the read weather information is “fine” or “cloudy”, these items are already registered to the option listing database (“YES” in S3-4). Therefore, 1 is added to a column of the number of people, which corresponds to this weather.

By repeating the above described process, an addition process is sequentially performed for the column of the number of people, which corresponds to each weather information. In this way, the option listing database is generated.

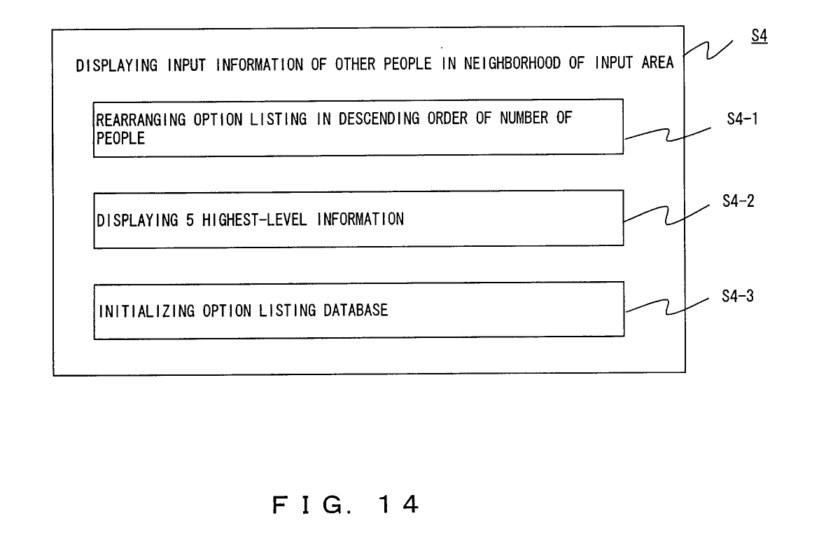

Next, a result of the above described statistical process, namely, input information of other people is displayed (S4 shown in FIG. 7). FIG. 14 is a flowchart specifically explaining this process. Firstly, weather information is rearranged in descending order of the number of people based on the information registered to the above described option listing database (S4-1). Next, weather information whose numbers of people are the first to the fifth largest are displayed (S4-2). For instance, in the above described example shown in FIG. 13, the number of people for the item “fine” is 10, the number of people for the item “cloudy” is 2, and the number of people for the item “rainy” is 1. Accordingly, in this case, “fine”, “cloudy”, and“rainy” are rearranged in this order, and displayed in a higher-level option display portion 18 as shown in FIG. 8. After this process, the option listing database is initialized (S4-3).

The processes are performed as described above, so that a place name specified in the higher-level option display portion 18, and weather information in the vicinity of the place name are displayed, and a customer can input weather information to his or her own calendar by referring to the weather information displayed in the higher-level option display portion 18. This input process can be performed by specifying any one of the weather information displayed in the higher-level option display portion 18.

An input process that does not use the higher-level option display portion 18 in this preferred embodiment can be specified by referencing the weather listing display portion 19 shown in FIG. 8B, and by selecting a corresponding mark. For example, if information “fine” is input, (1) of the weather listing display portion 19 is selected. Or, if “fine, cloudy later” is selected, (2) of the weather listing display portion 19 is selected. If “fine, rainy later” is selected, (3) of the weather listing display portion 19 is selected. If “fine, snowy later” is selected, (4) of the weather listing display portion 19 is selected. If “fine, thunder later” is selected, (5) of the weather listing display portion 19 is selected. Additionally, if “cloudy”, “rainy”, etc., is selected, specification can be made by selecting corresponding weather icons (6), (7), etc. in the weather listing display portion 19.

As described above, according to this preferred embodiment, when a customer inputs weather information, he or she can specify the information by referring to weather information in the vicinity of a region or a place name that the user desires to input. Moreover, the weather information is displayed in descending order of the number of people, and also the number of people specified in the past can be specifically displayed. As a result, more accurate weather information can be easily input.

<Second Preferred Embodiment>

A second preferred embodiment according to the present invention is explained next.

This preferred embodiment takes advantage of information of a region where a purchaser resides as attribute information in order to determine the perception or the popularity of a color at the time of a commodity purchase. A specific explanation is provided below.

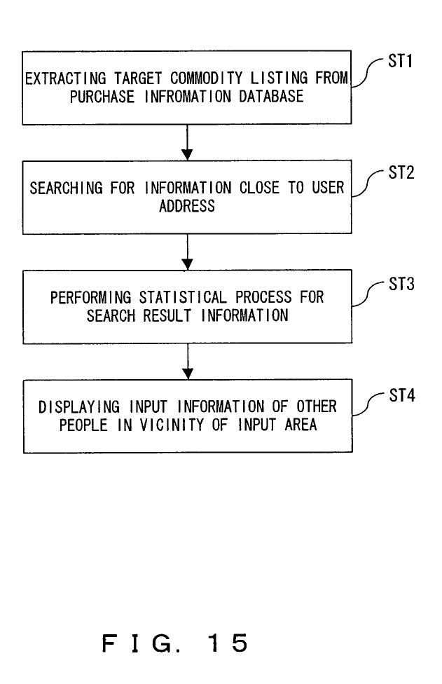

FIG. 15 is a flowchart explaining processes in this preferred embodiment. The assumption that a user receives user authentication beforehand by inputting his or her customer ID and password as a preprocess of this flowchart is similar to the above provided explanation about the flowchart shown in FIG. 9.

Firstly, a target commodity listing is extracted from a customer purchase information database (ST1), and purchase information of customers whose addresses are close to that of a user is extracted in a similar manner as in the above described process (ST2). Next, a statistical process is performed for search result information (ST3). Input information of other people is displayed on the terminal of the user (ST4), and the user uses this information as a reference for selecting a color when purchasing the same commodity.

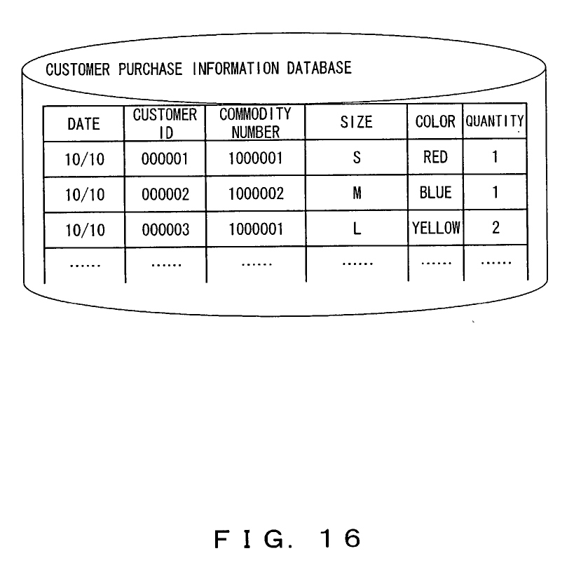

The respective processes are specifically explained below. In this preferred embodiment, a purchase information database is built in the above described storage device 3. Commodity purchase information input from users via terminals are stored in this database. For example, FIG. 16 explains the data structure of the purchase information database. This database stores a customer ID, a commodity number, a size, a color, and a purchase quantity. By way of example, for a customer ID “000001”, a commodity number “1000001”, and data such as a size S, a color red, and a purchase quantity 1 are stored. Additionally, for a customer ID “000002”, a commodity number “1000002”, and data such as a size “M”, a color “blue”, and a purchase quantity “1” are stored. Similarly, subsequent information is stored as shown in FIG. 16.

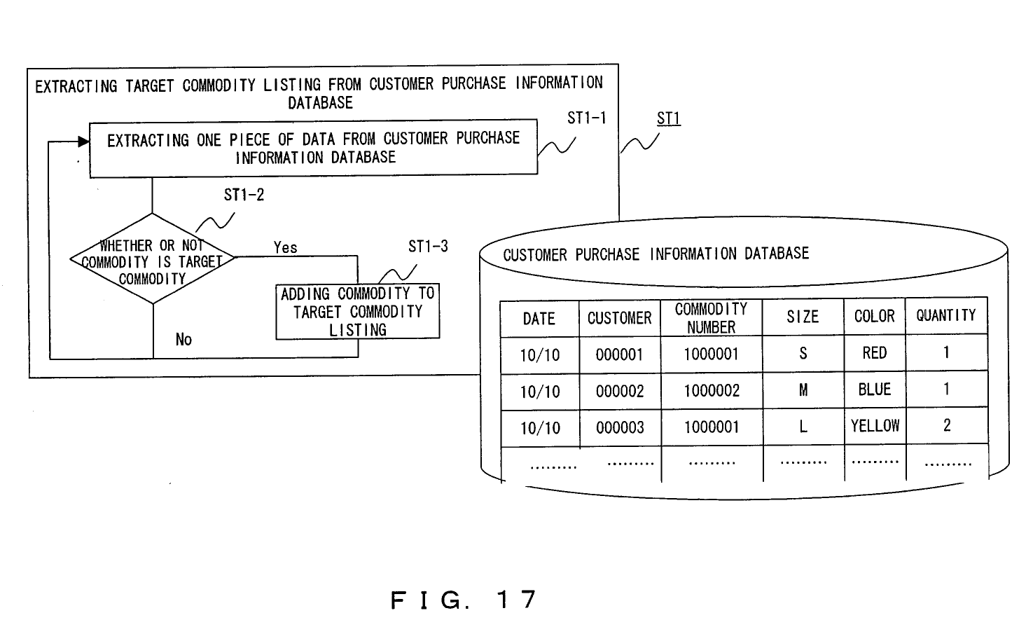

FIG. 17 shows a process for extracting a target commodity listing from the purchase information database (ST1 shown in FIG. 15) Firstly, one piece of data is read from the purchase information database (ST1-1). By way of example, for a customer having a customer ID “000001”, a commodity number “1000001” of this customer is read out.

Next, it is determined whether or not a commodity having the read commodity number “1000001” is a target commodity (ST1-2). For example, it is determined whether or not the commodity number of the read commodity matches the commodity number of a commodity from which color information is to be obtained. Here, if both of the numbers match (“YES” in step ST1-2), the read commodity is added to the target commodity listing (ST1-3). If both of the numbers mismatch (“NO” in ST1-2), the next one piece of data is read from the purchase information database (ST1-1).

By repeating the above described process, information of all of commodities registered to the purchase information database are sequentially read out, and confirmed.

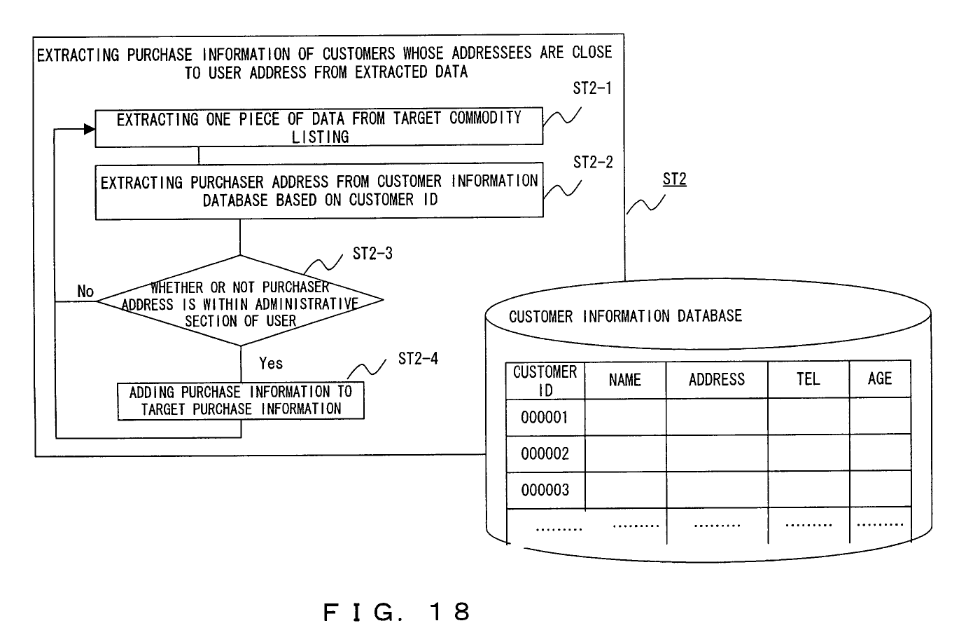

Next, purchase information of customers whose addresses are close to that of a user is extracted from the data extracted with the above described process (ST2 shown in FIG. 15). FIG. 18 is a flowchart specifically explaining this process. Also in this case, one piece of data is first read from a target commodity listing (ST2-1), and address information of a purchaser is read from the customer information database (ST2-2). Then, it is determined whether or not the address of the purchaser is within an administrative section of the user (ST2-3).

If the address of the purchaser is not within the administrative section (“NO” in ST2-3), the next piece of data is further read out. If the address of the purchaser is within the administrative section (“YES” in ST2-3), the purchase information is added to the target purchase information (ST2-4). By repeating the above described process, only color information of the target commodity purchased by customers whose addresses are close to the address of the user can be extracted.

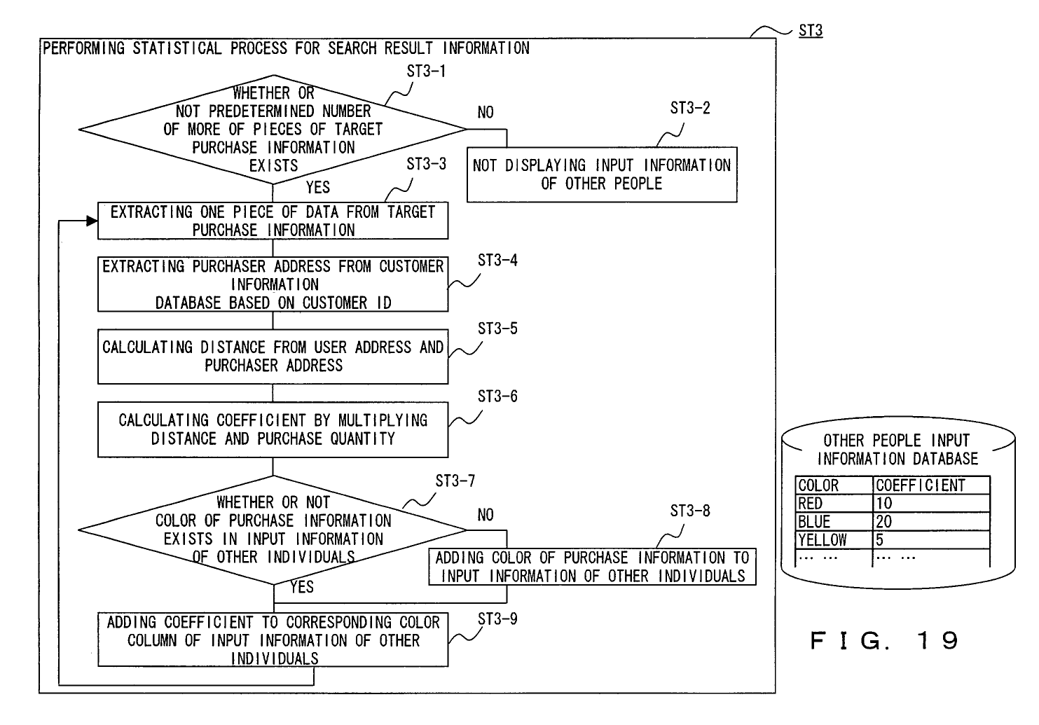

Next, a statistical process is performed for information of the search result (ST3 shown in FIG. 15). FIG. 19 is a flowchart specifically explaining this statistical process. Firstly, it is determined whether or not a predetermined number or more of pieces of data exists in the input information listing obtained from the above described search result (ST3-1). Here, if the predetermined number or more of pieces of data does not exist (“NO” in ST3-1), color information of other people is not displayed (ST3-2). The reason is that the amount of data is small, and is unavailable as information for making a determination for a person who makes an input in this case. In the meantime, if the predetermined number or more of pieces of data exists (“YES” in ST3-1), one piece of data is read from the target purchase information (ST3-3).

Next, address information of the purchaser is read from the customer information database, and a distance is calculated from the address of the user and that of the purchaser (ST3-4, ST3-5). Then, a coefficient is calculated by multiplying the distance and a purchase quantity (ST3-6). Since this process is losing its meaning as regional information with a decrease in the distance, the purchase quantity is multiplied by the distance.

Next, it is determined whether or not the color of the purchase information exists in input information of other people (ST3-7). Here, if the color of the purchase information does not exist in the input information of other people (“NO” in ST3-7), the read color information is added to the input information of other people (ST3-8). In the meantime, if the color of the purchase information exists in the input information of other people (“YES” in ST3-7), a coefficient is added to the item of the corresponding color of the input information of other people (ST3-9). The coefficient calculation in this case is calculated as described above. By repeating the above described process, an input information database of other people is generated.

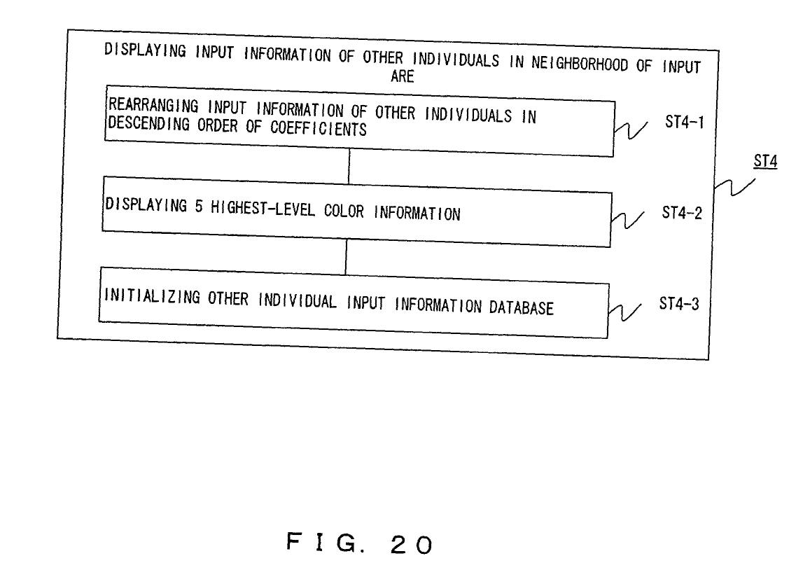

Next, the input information of other people is displayed (ST4 shown in FIG. 15). FIG. 20 is a flowchart specifically explaining this process. Firstly, color information is rearranged in descending order of coefficients based on the information registered to the option listing database (ST4-1). Next, 5 highest-level colors are displayed (ST4-2). For instance, in the example shown in FIG. 19, a coefficient of “blue” is 20, which is the largest. A coefficient of “red” is 10, which is the second largest. A coefficient of “yellow” is 5, which is the third largest. Accordingly, the colors are displayed in the higher-level option display portion in this order. After the above described process, the input information database of other people is initialized (ST4-3).

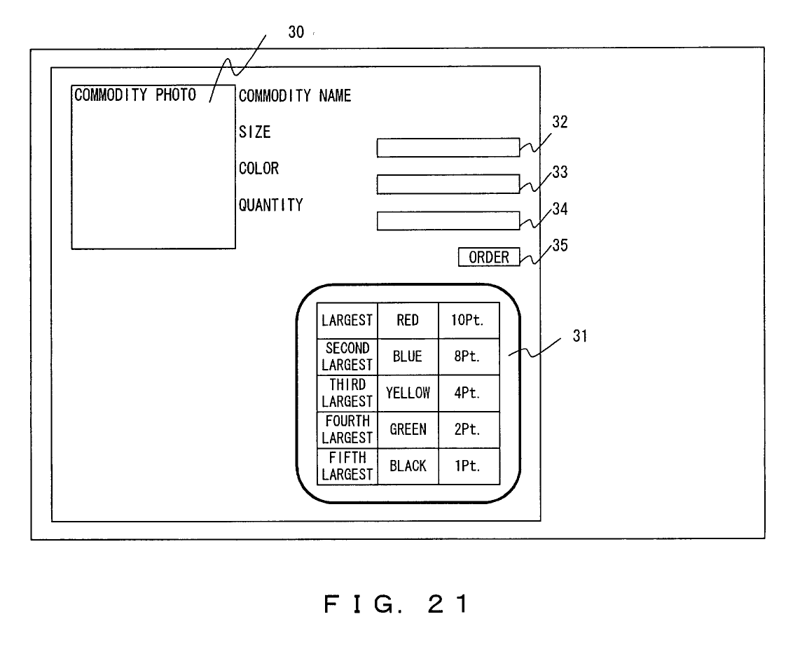

FIG. 21 shows the state where a color popularity order is made visible on a display of a user terminal 2 as a result of the above described process. For instance, a commodity photo is displayed in 30 shown in FIG. 21. A user verifies the popularity of colors displayed in a higher-level option display portion 31, and inputs color information of the commodity. This color information is input to a color information input portion 33 shown in this figure.

At the same time, size information and quantity information are respectively input to a size input portion 32, and a quantity input portion 34 as shown in this figure. When the size, the color, and the quantity information are input, these information are transmitted to the server 1 by a selection of an order button 35, which is made by a user.

By performing the process as described above, color information of a target commodity (commodity number) is displayed in order of coefficients, the popularity of the color of the commodity in the vicinity of the address of a person who makes an input can be determined, and this information can be used as information for making a determination, for example, when the commodity is purchased. Accordingly, the trend of purchasers in the vicinity can be learned, and information for making a determination is provided to a customer, which very much facilitates the determination of a person who makes an input.

The above described preferred embodiments refer to “weather” and “colors” as information. However, the present invention is not limited to “weather” and “colors”. Information of the shape of a commodity, the use frequency of a theme park, an amusement park, or a park in a corresponding region, and the like may be provided as information. Also other various items of information can be targeted as information of the present invention.

The above described preferred embodiments exemplify the cases where regional information (an address of a user) is used for a statistical process. However, the present invention is limited to regional information. The statistical process may be performed, for example, by using an individual attribute of a user, such as gender, age, etc.

As described above in detail, according to the present invention, option status of other users can be learned, and moreover, information of other users, for which a statistical process is performed, can be learned. Therefore, a user can determine regional information based on sufficient information for making a selection.

Furthermore, positional information is possessed, so that option information with higher reliability can be obtained, and the domicile or the current location of a user, or information of the likings or the popularity of other users residing in the vicinity of the places. As a result, more effective option can be made.

What is claimed is:

1. An information processing method, comprising:
storing information that is recognized differently depending on an individual in a storing unit in correspondence with a predetermined attribute;
searching the storing unit according to an attribute specified by a terminal, and reading information corresponding to the attribute;
performing a statistical process for the information read by said searching, and transmitting the information to the terminal; and
inputting information determined based on statistical information transmitted by said transmitting.

2. The information processing method according to claim 1, wherein
the information stored in the storing unit is provided from a plurality of terminals, and stored.

3. The information processing method according to claim 1, wherein
the statistical process is a process for classifying the information into levels by frequency.

4. The information processing method according to claim 1, wherein
the information is weather information of a region, and the attribute is address information of a user who uses the terminal.

5. The information processing method according to claim 1, wherein
the information is attribute information of a commodity to be purchased, and the attribute is an individual attribute of a user who uses the terminal.

6. An information processing system where an information processing server and a terminal are connected via a network, comprising:
a storing unit storing information that is recognized differently depending on an individual in correspondence with a predetermined attribute;
a searching unit searching the storing unit according to an attribute specified by a terminal, and reading information corresponding to the attribute;
a transmitting unit performing a statistical process for the information read by said searching unit, and transmitting the information to the terminal; and
an inputting unit inputting information determined based on statistical information transmitted by said transmitting unit.

7. The information processing system according to claim 6, wherein
the information stored in said storing unit is provided from a plurality of terminals, and stored.

8. The information processing system according to claim 6, wherein
the statistical process is a process for classifying the information into levels by frequency.

9. The information processing system according to claim 6, wherein
the information is weather information of a region, and the attribute is address information of a user who uses the terminal.

10. The information processing system according to claim 6, wherein
the information is attribute information of a commodity to be purchased, and the attribute is an individual attribute of a user who uses the terminal.

11. An information processing server connected to a terminal via a network, comprising:
a storing unit storing information that is recognized differently depending on an individual in correspondence with a predetermined attribute;
a searching unit searching the storing unit according to an attribute specified by the terminal, and reading information corresponding to the attribute; and
a transmitting unit performing a statistical process for the information readby said searching unit, and transmitting the information to the terminal.

12. The information processing server according to claim 11, wherein
the information stored in the storing unit is provided from a plurality of terminals, and stored.

13. The information processing server according to claim 11, wherein
the statistical process is a process for classifying the information into levels by frequency.

14. The information processing server according to claim 11, wherein
the information is weather information of a region, and the attribute is address information of a user who uses the terminal.

15. The information processing server according to claim 11, wherein
the information is attribute information of a commodity to be purchased, and the attribute is an individual attribute of a user who uses the terminal.

16. A terminal connected to an information processing server via a network, comprising:
a transmitting unit transmitting information that is recognized differently depending on an individual to the information processing server;
a receiving unit receiving a result of a statistical process, which is performed by the information processing server based on the information transmitted by said transmitting unit, from the information processing server; and
an inputting unit inputting information determined based on statistical information received by said receiving unit.

17. An information processing program, which can be executed by a computer connected to a terminal via a network, comprising:
storing information that is recognized differently depending on an individual in a storing unit in correspondence with a predetermined attribute;
searching the storing unit according to an attribute specified by a terminal, and reading information corresponding to the attribute; and
performing a statistical process for the information read by said searching, and transmitting the information to the terminal.

18. An information processing program, which can be executed by a computer connected to an information processing server via a network, comprising:
transmitting information that is recognized differently depending on an individual to the information processing server;
receiving a result of a statistical process, which is performed by the information processing server based on the information transmitted by said transmitting, from the information processing server; and
inputting information determined based on statistical information received by said receiving.

19. A storage medium on which is recorded an information processing program, which can be executed by a computer connected to a terminal via a network, for causing the computer to execute a process, the process comprising:
storing information that is recognized differently depending on an individual in a storing unit in correspondence with a predetermined attribute;
searching the storing unit according to an attribute specified by a terminal, and reading information corresponding to the attribute; and
performing a statistical process for the information read by said searching, and transmitting the information to the terminal.

20. A storage medium on which is recorded an information processing program, which can be executed by a computer connected to an information processing server via a network, for causing the computer to execute a process, the process comprising:
transmitting information that is recognized differently depending on an individual to the information processing server;
receiving a result of a statistical process, which is performed by the information processing server based on the information transmitted by said transmitting, from the information processing server; and
inputting information determined based on statistical information received by said receiving.

21. An information processing method, comprising:
receiving an option item corresponding to information, which is selected by a plurality of terminals from among a plurality of option items associated with the information to be selected, and registering the received option item to a registering unit;
performing a statistical process for a result of the option registered to the registering unit;
transmitting information indicating a result of the statistical process to a terminal along with the plurality of option items associated with the information to be selected; and
inputting information determined based on the information indicating the result of the statistical process transmitted by said transmitting.

22. An information processing system where an information processing server and a terminal are connected via a network, comprising:
a receiving unit receiving an option item corresponding to information to be selected, which is a result of a selection made by a plurality of terminals from among a plurality of option items associated with the information to be selected;
a registering unit registering an option item corresponding to the information received from each terminal;
a statistical processing unit performing a statistical process for the result of the selection registered to said registering unit;
a transmitting unit transmitting information indicating a result of the statistical process to a terminal along with the plurality of option items associated with the information to be selected; and
an inputting unit inputting information determined based on the information indicating the result of the statistical process, which is transmitted by said transmitting unit.

23. An information processing server connected to a terminal via a network, comprising:
a receiving unit receiving an option item corresponding to information to be selected, which is a result of a selection made by a plurality of terminals from among a plurality of option items associated with the information to be selected;
a registering unit registering the option item corresponding to the information, which is received from each terminal;
a statistical processing unit performing a statistical process for the result of the selection, which is registered to said registering unit; and
a transmitting unit transmitting a result of the statistical process to the terminal along with a plurality of option items associated with the information to be selected.

24. An information processing program, which can be executed by a computer connected to a terminal via a network, comprising:
receiving an option item corresponding to information to be selected, which is a result of a selection made by a plurality of terminals from among a plurality of option items associated with the information to be selected;
registering the option item corresponding to the information received from each terminal;
performing a statistical process for the result of the selection, which is registered to said registering unit; and
transmitting a result of the statistical process to the terminal along with a plurality of option items associated with the information to be selected.
